(19) United States
(12) Patent Application Publication
(10) Pub. No.: US 2013/0185897 A1
(43) Pub. Date: Jul. 25, 2013

(54) DOOR KNOB SANITIZER

(71) Applicant: Vernon Bracey, Detroit, MI (US)

(72) Inventor: Vernon Bracey, Detroit, MI (US)

(21) Appl. No.: 13/744,465

(22) Filed: Jan. 18, 2013

Related U.S. Application Data
(60) Provisional application No. 61/588,408, filed on Jan. 19, 2012.

(51) Int. Cl. E05B 1/00

(52) U.S. Cl. CPC E05B 1/0069
USPC 16/110.1

(57) ABSTRACT

A three dimensional shaped body constructed of a sanitary plastic, with an inner surface of the body defining a hollow interior which facilitates application over the door hardware and provides frictional engagement against a surface of the hardware. The body exhibits an end face from which projects an undulating and perimeter extending skirt, the design of which providing additional fabric which, upon being grasped and rotated by a user, can be circumferentially deflected and folded over against itself and the underlying surfaces of the rotatable door knob over which the cover is installed, this in order to facilitate additional frictional engaging contact with the door handle. An inside surface of the body can also exhibit any desired tacky surface in order to provide additional gripping engagement of the handle or knob.

### CROSS REFERENCE TO RELATED APPLICTIONS

The present application claims the priority of U.S. Ser. No. 61/588,408, filed Jan. 19, 2012.

### FIELD OF THE INVENTION

The present invention relates to a flexibly applied article for fitting over a handle, knob or other like configured hardware fitting associated with a door in order to reduce the incidence of germ transmission and the like.

### BACKGROUND OF THE RELEVANT ART

The prior art is documented with examples of sanitary door knob covers or appliques. These include each of the sanitary and disposable cover of Willis, U.S. Pat. No. 6,546,594, the sanitary door knob of Millar, U.S. Pat. No. 3,314,746, the multi-surface anti-bacterial protective device of Williams U.S. Pat. No. 6,821,325, the door handle cover of Herron, Jr., US 2006/0006678, the sanitary door handle with material advancing mechanism of Hawkins, U.S. Pat. No. 4,658,469, the touchless door pull apparatus of Krawczyk, U.S. Pat. No. 6,353,971, and the sanitary door knob of Millar, U.S. Pat. No. 3,314,746.

An additional class of prior art references deals with other types of secondary systems for providing a spray or cleaning application over an existing door handle surface and this includes each of the door sanitation system of Lidahl, U.S. Pat. No. 6,508,383, the door knob sanitizing device of Butterfield, U.S. Pat. No. 6,298,521, the door handle sanitizer system and apparatus of Sasson, US 2006/0153733, the apparatus and method for providing a continuously sanitized contact surface of Dawson, U.S. Pat. No. 6,645,435, the door handle disinfecting cover dispensing system of Gaudreau, U.S. Pat. No. 6,789,695 and the device for disinfecting door handles in Callueng, U.S. Pat. No. 6,874,697.

### SUMMARY OF THE PRESENT INVENTION

The present invention teaches a sanitary attachment unlike these described in the afore-mentioned references and which is configured for resistive application onto conventional door handle hardware. A three dimensional shaped body is constructed of a sanitary plastic, with an inner surface of the body defining a hollow interior which facilitates application over the door hardware and provides frictional engagement against a surface of the hardware.

In a preferred application, the body exhibits an end face from which projects an undulating and perimeter extending skirt, the design of which providing additional fabric which, upon being grasped and rotated by a user, can be circumferentially deflected and folded over against itself and the underlying surfaces of the rotatable door knob over which the cover is installed, this in order to facilitate additional frictional engaging contact with the door handle. An inside surface of the body can also exhibit any desired tacky surface in order to provide additional gripping engagement of the handle or knob.

Additional variants can include the body exhibiting a pseudo tire shape or an elongated and axially split body. In another variant, the body may exhibit an elongated and arcuate shape defined by spaced apart top, bottom and first and second sides which converge at a remote end. The body can also exhibit any material including transparent, semi-transparent or opaque composition and it is further envisioned that any type of sanitary composition can be either applied to or chemically integrated into the composition of the cover, this ranging from a generic and commercially available (Lysol like) spray to any proprietary composition for retarding or preventing the growth of any bacterial or viral deposits.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a partially exploded view of a door cover according to a first embodiment of the present invention;

FIG. 2 is an assembled perspective of the door cover depicted in FIG. 1 in which it is assembled over a standard rotatable door knob in a fashion to facilitate over-folding of the peaks or ridges defined by the circumferentially spaced apart portions of the fabric against adjacent locations of the fabric and in order to enhance both tactile/resistive gripping and engagement of the door handle;

FIGS. 3A and 3B depict an elongated and flexible cover exhibiting a lengthwise slit for fashioning around a “U” shaped handle;

FIGS. 4 and 5 exhibit additionally configured sanitary attachments associated with various door hardware;

FIGS. 6 and 7 depict a further example of a door cover similar to that shown in FIG. 1 and which exhibits a ring-like flexible inner band for assisting in engaging over a narrowed neck profile associated with the door knob hardware; and

FIGS. 8-9, 10-11 and 12-13 exhibit respective front and side illustrations of additional configured door knob sanitizer covers.

### DETAILED DESCRIPTION OF THE PREFERRED EMBODIMENTS

As previously described, the present invention relates to a flexibly applied article for fitting over a handle, knob or other like configured hardware fitting associated with a door in order to reduce the incidence of germ transmission and the like. As will be further described in reference to each of the succeeding embodiments, the basic article exhibits a flexible and sanitary plastic construction, such as including but not limited to the use of an antiseptic material similar to a Clorox or Lysol base composition, as well as any type of proprietary composition exhibiting any combination of anti-bacterial, anti-viral or anti-fungal properties, and which can be chemically impregnated, coated or otherwise entrained into a polymeric matrix from which the plasticized material is constructed, shaped or otherwise formed.

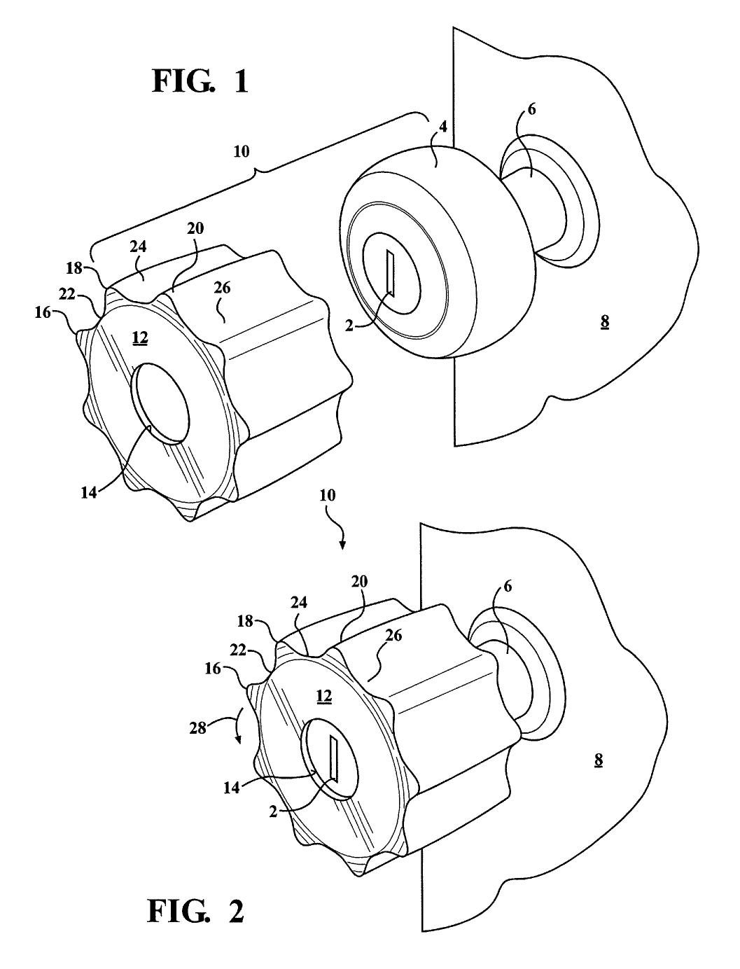

FIGS. 1-2 depict a first version 10 of sanitary attachment which exhibits a generally three dimensional shaped and flexible body constructed of a deformable but semi-form retaining material, such as a semi-rigid plastic or the like. The body exhibits a circular end face 12 with an inner perimeter defined surface 14 which, as further depicted in the assembled view of FIG. 2, is configured to expose a key slot 2 of a conventional and rotatable door knob 4, this in turn mounted via a narrowed neck 6 to a door 8.

Extending in circumferential fashion from the end face 12 is a skirt portion exhibiting a plurality of peaks or ridges 16, 18, 20, et seq., these alternating with valleys 22, 24, 26, et. seq., and which collectively establish an undulating pattern around the end face 12. This construction will permit the material within the peaks 16, 18, 20 et seq., to individually fold-over a minimal degree, see arrow 28 in FIG. 2, upon the user grasping and rotating the handle with the cover applied there-over, this in order to retract the jamb engaging latch.

In this fashion, the material to material contact locations established by the peaks circumferentially folding against the alternating valleys will result in additional frictional inducing gripping forces, this limiting the incidences of slippage or rotation of the cover relative to the underlying (typically metal) surface of the door knob 4. It is also envisioned that the inside surfaces of the pseudo collar shaped attachment 10 can exhibit a tacky or gripping surface to facilitate or provide an extra measure of frictional engaging or circumferential gripping force additional to that provided by the undulating pattern defined around the body.

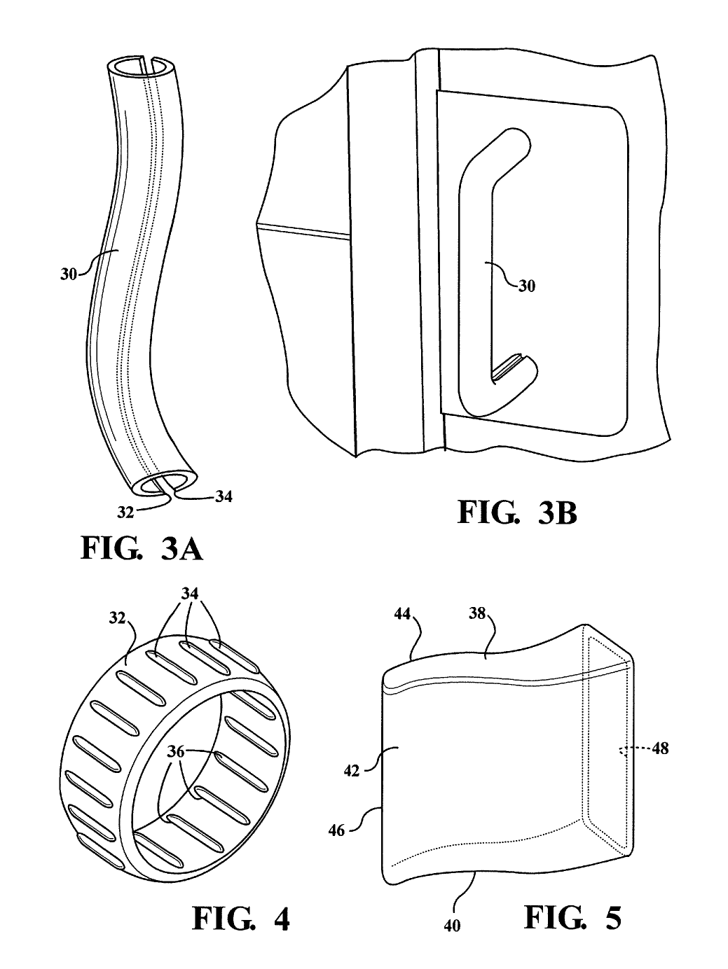

In this fashion, the attachment 10 is configured such that it is capable of being flexibly and resistively applied in the manner illustrated for covering the exterior of the conventional door knob. The desired degree of frictional engagement can be provided both by the natural physical and material properties of the plastic from which the attachment article is constructed and/or can further include the application of an additional tactile/frictional engagement coating, ingredient, surface profile (e.g. bumps and/or other shaped protuberances), such as including any specific configuration beyond that illustrated, and which can enhance or increase the engaging aspect of any variation of the attachment articles, including but again not limited to those subsequently described herein, when applied over the knob or handle shaped (see FIG. 3B) underlying door hardware. In each variant described, the sanitary article can exhibit any of a transparent, semi-transparent or opaque construction according to the desires of the user.

Referring to FIG. 3A, a second configuration of attachment includes an elongated sleeve shaped body 30, such as again can include a flexible and plasticized material, and which is designed with a lengthwise slit configured and lengthwise opposing edges 32 and 34 defining an axially split arrangement and permitting the body 30. The body is capable of being flexibly installed in the manner shown in FIG. 3B to a substantially “U” shaped handle (FIG. 3B) upon being manipulated to bend around the length of the handle and to restrain the sanitary article 30 in place over the handle.

A further attachment 32 is depicted in FIG. 4 and exhibits a generally ring, disk, tire or collar shaped article, again constructed of a flexible or deformable material, and which exhibits both outer 34 and inner 36 circumferentially spaced pluralities of protuberances for gripping each of the user's palm and fingers as well as the outer annular surfaces of the door knob 4 upon installing the attachment 32 to the knob by physically manipulated or stretching the plasticized ring shaped article 32 so as to apply over the conventional style door knob similar to that previously illustrated. The protuberances 34 and 36 are depicted by both outer and inner elongated profiles, it being understood that any alternate pattern or configuration is capable of being substituted for providing any desired optimal gripping surfaces to the attachment.

FIG. 5 depicts a fourth alternate example of an attachment depicted by an elongated body exhibiting an outer three dimensional and elongated/wave like or arcuate shape including top 38, bottom 40, first undulating side 42 and second undulating side 44 which converge at a remote extending end 46. An interiorly open end (further generally defined by rectangular profile 48 in phantom) facilitates bending and stretching application (similar to a sock or glove) of the attachment article onto a like arcuate configured handle (not shown but such as is common with many contemporary door hardware designs).

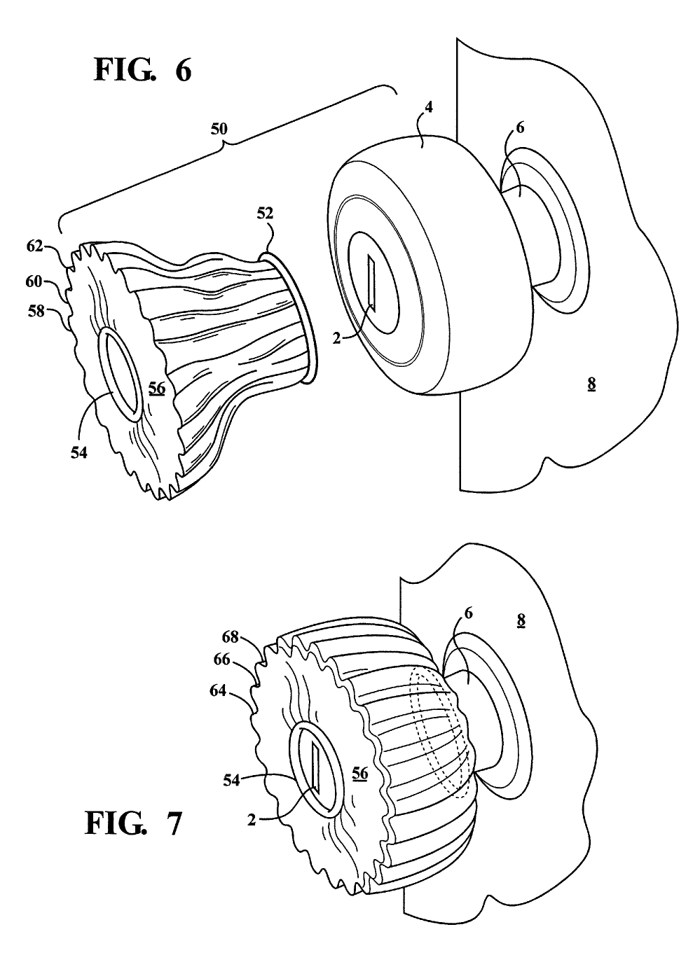

FIGS. 6 and 7 depict a further example, generally at 50, of a door knob attachment similar to that shown in FIG. 1 and which exhibits a ring-like flexible inner band 52 for assisting in engaging over the narrowed neck profile 6 associated with the door knob hardware. The attachment 50 otherwise exhibits an alternating ribboned or undulating pattern as compared to that shown in FIGS. 1-2 and also includes similar features including the keyhole revealing perimeter 54.

Extending in circumferential fashion from end face 56 is a skirt portion exhibiting a different configuration of alternating peaks (58, 60, 62, et seq. in FIG. 6) and valleys (64, 66, 68, et. seq. in FIG. 7) which collectively establish an undulating pattern around the end face 56. As with the initial variant of FIGS. 1-2, this construction will permit the material within the peaks to individually compress and/or fold-over a minimal degree the alternating valleys, and upon the user grasping and rotating the handle with the cover applied there-over, this in order to retract the jamb engaging latch. Otherwise, the attachment 50 can exhibit a softer material with more flexibility overall than is shown by the alternate variant 10 of FIGS. 1-2.

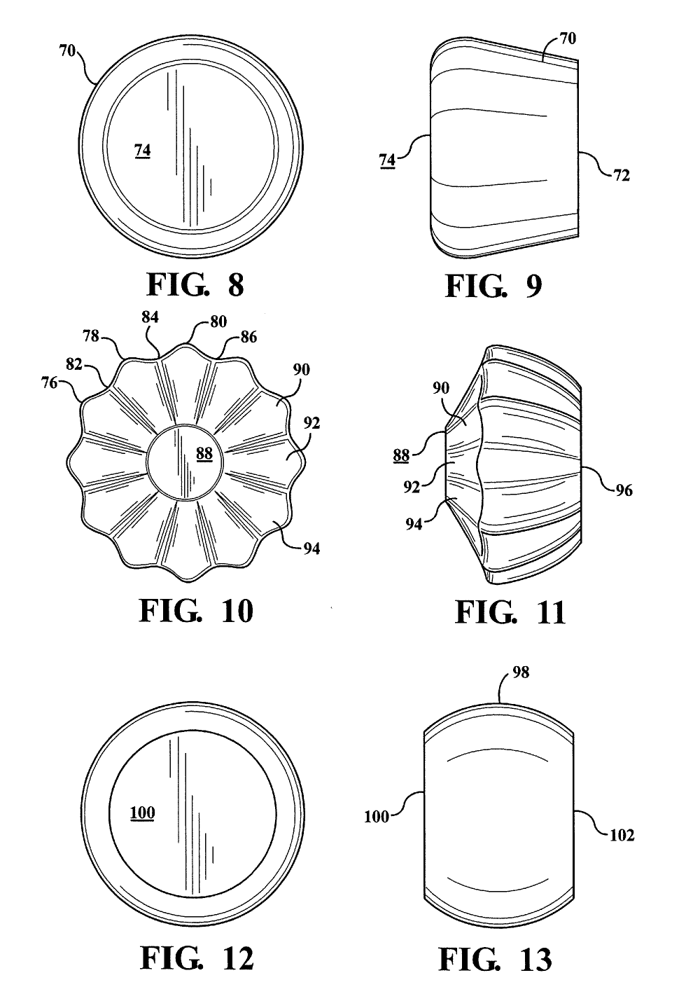

FIGS. 8-9 exhibit respective front and side illustrations of a door knob sanitizer cover according to a first variant and which includes a sloping side wall 70 extending between an inner open perimeter defining knob seating end 72 for manipulating over the circumference of the conventional door knob 2 and an outer end face 74.

FIGS. 10-11 depict front and side views of a further variant of cover attachment including a sloping and undulating side skirt, see alternating peaks 76, 78, 80, et seq. and valleys 82, 84, 86 et seq. A narrowed diameter outer end face 88 is spaced from the outer most diameter locations of the skirt by a plurality of forward/inward tapered surfaces 90, 92, 94, et seq., with an innermost knob seating end 96 provided for flexibly affixing over the door knob 4.

Finally, FIGS. 12-13 depict another possible variation of door knob attachment cover exhibiting a convex and skirt defining side wall 98 separating a forward end face 100 and an inner (open) end 102 for affixing over the outer circumference of the knob.

Having described my invention, other and additional preferred embodiments will become apparent to those skilled in the art to which it pertains, and without deviating from the scope of the appended claims.

I claim:

1. A sanitary attachment for covering a conventional door hardware, said attachment comprising:
a three dimensional shaped body constructed of a sanitary and flexible plastic; and
an inner surface of said body defining a hollow interior which facilitates application over the door hardware and provides frictional engagement against exposed surfaces of the hardware.

2. The sanitary attachment as described in claim 1, said body further comprising a circumferentially extending skirt extending between an inner knob seating end and an outer end face.

3. The sanitary attachment as described in claim 2, said skirt further comprising alternating pluralities of peaks and valleys which define an overall undulating and circumferential extending profile.

4. The sanitary attachment as described in claim 1, said body further comprising any of a ring, disk, collar or pseudo tire shape.

5. The sanitary attachment as described in claim 1, said body further comprising an elongated and axially split body.

6. The sanitary attachment as described in claim 1, said body further comprising an elongated and arcuate shape defined by spaced apart top, bottom and first and second sides which converge at a remote end.

7. The sanitary attachment as described in claim 1, said body further comprising a material composition exhibiting any of a transparent, semi-transparent or opaque composition.
